(19) United States
(12) Patent Application Publication
(10) Pub. No.: US 2004/0170789 A1
(43) Pub. Date: Sep. 2, 2004

(54) Annealed polypropylene pipes and fittings

(76) Inventors: Emmanuel Michel Delaite, Braine-Le-Comte (BE); Virgile Joel Maurice Rouyer, Brussels (BE)

Correspondence Address: BP America Inc, BP Legal, 4101 Winfield Road, Mail Code 5 East, Warrenville, IL, 60555, US

(21) Appl. No.: 10/480,087

(22) PCT Filed: Jun. 12, 2002
(86) PCT No.: PCT/EP02/06438

(30) Foreign Application Priority Data
Jun. 15, 2001 (BE) 2001/0404

(51) Int. Cl. B26D 3/16; B29C 45/00; B29C 71/02; B32B 1/08

(52) U.S. Cl. 428/36.9; 264/235; 264/150; 264/328.1

(57) ABSTRACT

A process of manufacture of pipes and of fittings comprising a first stage of utilising a propylene polymer based compound comprising: from 76 to 98 parts by weight of a crystalline homopolymer of propylene or of a crystalline statistical copolymer (A) of propylene which may contain up to 1.5% molar of monomer units derived from ethylene and/or from an alpha-elefin containing from 4 to 6 carbon atoms; from 24 to 2 parts by weight of a statistical copolymer (B) containing from 40 to 70% molar of monomer units derived from ethylene and/or from an alpha-olefin containing from 4 to 6 carbon atoms, so as to obtain a pipe or a fitting, and a second stage of annealing said pipes or fittings by heating for a perior of between one hour and three days at a temperature between 110 and 155° C.

The present invention concerns a process of manufacture of pipes and fittings, and pipes and fittings obtained according to that process. It also concerns the use of these pipes and fittings for the conveying of fluids at low pressure and under elevated pressure.

A known practice is to apply annealing to polypropylene-based objects in order to improve their mechanical properties. Thus Ito et al.'s document in J. of Appl. Polym. Sci., 1992, 46, 1221 and patent application JP 76/006190 describe annealing applied to sequenced copolymers of propylene to provide improved impact resistance. JP 51/047947 describes annealing of pipes based on sequenced copolymers of propylene. JP 05/293907 describes annealing of polypropylene based pipes. However, the pipes described in those documents do not have optimum mechanical properties, notably in terms of the “rigidity—shock resistance—resistance to slow cracking” compromise.

The object of the present invention is to provide a process for the manufacture of pipes and fittings by utilising a propylene polymer based compound, followed by annealing, which does not have the abovementioned disadvantages.

Accordingly, the present invention provides a process for the manufacture of pipes and fittings comprising a first stage of utilising a propylene polymer based composition comprising:

from 76 to 98 parts by weight of a crystalline homopolymer of propylene or of a crystalline statistical copolymer (A) of propylene that may contain up to 1.5% molar of monomer units derived from ethylene and/or from an alpha-olefin containing from 4 to 6 carbon atoms,

from 24 to 2 parts by weight of a statistical copolymer (B) containing 40 to 70% molar of monomer units derived from ethylene and/or from an alpha-olefin containing from 4 to 6 carbon atoms,

so as to obtain a pipe or a fitting,

and a second stage of annealing of said pipes and fittings by heating for a period of between one hour and three days at a temperature between 10 and 155° C.

The first stage of the process according to the invention may be any known technique for the manufacture of objects by molten mixing of the propylene polymer based composition, followed by moulding of the composition in the molten state. Extrusion, generally followed by a cutting

operation, is particularly well suited to the moulding of pipes. Injection-moulding is particularly well suited to the manufacture of fittings.

The quantity of polymer (A) contained in the compound utilised in the process according to the invention is advantageously at least 80 parts by weight. Polymer (A) contents of at most 97 parts by weight give particularly good results. Preferably, polymer (A) is a crystalline homopolymer of propylene.

The quantity of polymer (B) is most often 20 parts at most by weight, quantities of at least 3 parts by weight being particularly advantageous. Preferably, polymer (B) contains only monomer units derived from propylene and from ethylene. Statistical copolymers containing from 45 to 65% molar of monomer units derived from ethylene are particularly well suited.

The comonomer content mentioned in the present description is determined by Fourier transform IR spectrometry on the polymer converted into 400 μm pressed film. It is the absorption bands at 740 and 720 cm⁻¹ that are exploited for determining the content of monomer units derived from ethylene. The absorption band at 767 cm⁻, is used for determining the content of monomer units derived from 1-butene.

The melt fluidity index, hereinafter called MFI, of the compound utilised in the process according to the invention, is advantageously from 0.05 g/10 min to 1.5 g/10 min. Preferably, the MFI of the compound utilised in the process according to the invention is at least 0.1 g/10 min, more particularly at least 0.3 g/10 min. MFIs of at most 1.3 g/10 min are preferred and, more particularly, at most 1 g/10 min. Compounds whose MFI is at least 0.3 g/10 min and at most 0.8 g/10 min are particularly preferred. The use in the process of the invention of compounds whose MFI is at least 0.3 g/10 min affords the advantage of obtaining pipes and fittings capable of being welded to a larger range of pipes at lower cost. The use in the process according to the invention of compounds whose MFI is at most 0.8 g/10 min affords the advantage of obtaining pipes and fittings having good mechanical properties.

The composition utilised in the process according to the invention typically has an intrinsic viscosity ratio of polymer (B) to polymer (A) of 0.8 to 3. Advantageously this ratio is at least 0.9 and at most 2.

The intrinsic viscosity of the polymers is measured according to the method described in the Examples below.

Polymers (A) and (B) constitute at least 50% by weight, preferably at least 90% by weight, with respect to the total weight of the composition used in the process of the invention. The composition may also contain other polymers, filler materials, stabilisers, pigments, antiacids or nucleation agents. Preferably, the composition does not contain organic polymers other than polymers (A) and (B). Consequently, the respective quantities of polymers (A) and (B) utilised are such that their sum is equal to 100 parts by weight. Preferably, the compositions formed in the process of the invention are free from nucleating agents because this can provide a better “rigidity/shock resistance” compromise after annealing, at lower cost.

The composition of the invention may be obtained by any appropriate technique. It is for example possible to mix some polymer (A), some copolymer (B) and any additives together according to any known process such as, for example, the molten mixing of two preformed polymers. However, processes in the course of which polymers (A) and (B) are prepared in at least two successive polymerisation stages are preferred. The polymer thus obtained is generally called a sequenced copolymer of propylene. Generally, the procedure is first to prepare polymer (A) and then prepare copolymer (B) in the presence of the polymer (A) arising from the first polymerisation stage. The polymerisation stages may each be effected, independently of one another, in suspension or slurry in an inert hydrocarbon diluent, in propylene maintained in the liquid state or else in gaseous phase, in an agitated bed or in a fluidised bed.

The process according to the invention comprises a second stage of annealing the pipes and fittings. In the context of the present invention, “annealing” means an operation of prolonged heating of the cut pipe or the fitting obtained according to the first stage of the process according to the invention, below the melting temperature and above the vitreous transition temperature of said pipe or fitting, followed by slow cooling to ambient temperature. Advantageously the heating period does not exceed 48 hours. Heating periods of at least 2 hours, preferably at least 3 hours are preferred.

Heating times of at least 3 hours and at most 48 hours make it possible to obtain an optimum compromise between, on the one hand, the properties of rigidity, shock resistance and resistance to slow cracking and, on the other hand, the costs associated with the annealing.

The heating temperature is chosen advantageously between 120 and 150° C. Heating temperatures between 135 and 145° C. are particularly preferred, because they lead to pipes and fittings having optimum mechanical properties.

The period between the first and second stage of the process is not critical and may vary generally between a few minutes and few months. However, this period is preferably long enough to allow cooling to ambient temperature of the cut pipe or the fitting obtained in the first stage of the process.

The annealing step is typically carried out in any heated enclosure such as, for example, ovens with hot air circulation.

The annealing step makes it possible to improve the mechanical properties of pipes and of fittings, providing pipes and fittings that have simultaneously good rigidity, and resistance to impact, to shock and to slow cracking.

The process of the invention is particularly well suited to the manufacture of pipes and fittings intended for the conveying of low-pressure fluids such as the conveying of wastewater, sewage or drainage; these pipes and fittings therefore constitute particular objects of the present invention. The process of the invention is also particularly well suited to the manufacture of pipes and fittings intended for the conveying of fluids under elevated pressure such as water and gas distribution.

In the following Examples, the methods of measurement of the parameters mentioned therein, the units expressing those parameters and the meaning of the symbols used in these examples are explained below.

The intrinsic viscosity of the polymers is measured in tetraline at 140° C. by means of an Ostwald viscosimeter on solutions with 1.5 g/l of polymer.

The polymer fractions soluble in xylene (XS) are determined by putting 3 g of polymer into solution in 200 ml of m-xylene at boiling temperature, cooling the solution to 25° C. by immersion in a water bath and filtering the soluble fraction at 25° C. on filter paper corresponding to a standardised G2.

MFI: fluidity index of the compound, measured under 2.16 kg load at 230° C. according to standard ASTM 1238 (1998).

C₂ total: total ethylene content of the propylene polymer, expressed in % by weight and measured by infra-red spectrometry on a sample of the propylene polymer converted into film 400 μm thick, and defined as the sum of the relating ethylene contents which are evaluated by the absorbance of the characteristic bands at 720 cm⁻¹ and at 740 cm⁻.

[A]: quantity of polymer (A) present in the compound with respect to the total weight of polymer (A) and polymer (B), expressed in % by weight and estimated from the relationship: [A]=100−[B]

[B]: quantity of polymer (B) present in the compound with respect to the total weight of polymer (A) and polymer (B), expressed in % by weight and estimated by using the following equation:

$$[ B ] = \frac{100 \times ( XS - {XS}_{A} )}{( {XS}_{B} - {XS}_{A} )}$$

in which

XS: fraction soluble in m-xylene at 25° C. of the propylene based polymer, expressed in % by weight,

XS_{A}: fraction soluble in m-xylene in 25° C. of polymer (A), expressed in % by weight; in the case of sequenced copolymers, this value is measured on a sample taken from the first reactor,

XS_{B}: fraction soluble in m-xylene in 25° C. of polymer (B), expressed in % by weight; in the case of sequenced copolymers, this value is measured on a sample of polymer (B) prepared for the purpose and obtained in the same polymerisation conditions.

C₂ (B): ethylene content of polymer (B) expressed in % by weight and calculated by using the following relationship:

$${C}_{2} ( B ) = \frac{100 \times {C}_{2} total}{[ B ]}$$

β/α: intrinsic viscosity ratio of polymer (B) to polymer (A), determined from the relationship:

$$\frac{β}{α} = ( \frac{η}{α} - \frac{[ A ]}{100} ) / \frac{[ B ]}{100}$$

in which ρ represents the intrinsic viscosity of the mixture of polymers (A) and (B).

T°r D-F: transition temperature from ductile rupture to brittle rupture.

ESCR: Resistance to slow cracking (“Environmental Stress Cracking Resistance”) was measured according to ISO standard 1167 (1996).

### EXAMPLES 1-4

Four compositions was prepared comprising 100 parts by weight of a sequenced copolymer, containing a propylene homopolymer (polymer (A)) and a statistical copolymer (polymer (B)) obtained by polymerisation in suspension in hexane, having the characteristics given in Table 1 below:

| | EXAMPLE | | | |
|---|---|---|---|---|
| | 1 | 2 | 3 | 4 |
| MFI | 0.80 | 0.80 | 0.45 | 0.45 |
| C₂ total (wt %) | 6.8 | 6.8 | 4.2 | 4.2 |
| Amount B (wt %) | 14.5 | 14.5 | 9 | 9 |
| C₂ total in B (wt %) | 47 | 47 | 47 | 47 |
| β/α | 1.74 | 1.74 | 1.6 | 1.6 |
| Flexural modulus | 1300 | 1250 | 1730 | 1520 |
| (MPa) | | | | |
| Nucleating agent | None | None | 2 g/kg Na benzoate | None |
| Mn [kDa] | 78.1 | 80.9 | 103.6 | 96.9 |
| Mw [kDa] | 402.3 | 397.5 | 469.7 | 447.4 |
| Mn/Mw | 5.15 | 4.92 | 4.53 | 4.62 |
| Mz [kDa] | 1049 | 996 | 1139 | 1079 |
| Mz/Mw | 2.61 | 2.51 | 2.42 | 2.41 |

with the following additives:

0.1 parts by weight of pentaerythrityl tetrakis(3,5-ditert-butyl-4-hydroxyphenyl propionate) marketed under the designation IRGANOX® 1010 by the firm CIBA-GEIGY,

0.05 parts by weight of bis(2,4-ditertiobutylphenyl)pentaerythritol diphosphite marketed under the designation ULTRANOX® 626 by the firm GENERAL ELECTRIC, and

0.06 parts by weight of hydrotalcite DHT-4A

to 100 parts by weight of the compound.

The above compositions were extruded on a single-screw type extruder (BATTENFELD type) at 210° C. so as to obtain pipes having a diameter of 110 and 50 mm. In addition, for Examples 3 and 4, structured twin wall pipes having an internal diameter of 175 mm and an external diameter of 200 mm were extruded. Some of the pipes thus manufactured were subjected to annealing, by heat treatment at 140° C.±0.2° C. in air for a period of between 3 hours and 24 hours in a hermetic stove. Both annealed and non-annealed pipes were then evaluated according to the following tests. After extrusion, all the pipes were left for at least 15 days at room temperature before any annealing process; again, after their annealing process, the annealed pipes were left for at least 15 days at room temperature before any measurement. For the non-annealed samples, after their extrusion all the pipes were left for at least 15 days at room temperature prior to any measurement.

Physical Properties of Pipes

The reference standards prevailing in the field of sewerage & drainage pipes are the following:

| | |
|---|---|
| EN 1852-1 and prEN 1451-1: | for solid wall pipes |
| prEN 13476-1: | for structured twin-wall pipes |

Longitudinal Reversion: According to Standard EN 743

An average value was determined from tests on 3 samples of 10 mm pipes, each 200 mm long.

Sample length L₀ was measured at room temperature. The sample was then hung vertically for 60 minutes at 150° C. in an aerated oven, cooled slowly back to room temperature, and its length re-measured as L_{f}; reversion is calculated by

$$= \frac{{L}_{0} - {L}_{f}}{{L}_{0}} .$$

The performance requirement is that the degree of reversion is less than 2%, with no bubbles or cracks observed. Results are given in Table 2 below.

TABLE 2

| | | | Longitudinal |
|---|---|---|---|
| | OIT @ 190° C. | MFI @ 230° C. | reversion @ |
| EXAMPLE | [min.] | [g/10 min.] | 150° C. |
| 1-Non annealed | 24.3 | ˜0.80 | +0.33% |
| 1-Annealed 12h | — | — | −0.04 |
| 1-Annealed 24h | 30.8 | 0.64 | −0.06 |
| 2-Non annealed | 63.5 | ˜0.80 | +0.50 |
| 2-Annealed 12h | >80 | 0.64 | −0.14 |
| 3-Non annealed | >80 | — | +0.48 |
| 3-Annealed 12h | >80 | — | +0.04 |
| 4-Non annealed | >80 | — | +0.43 |
| 4-Annealed 12h | >80 | — | +0.04 |

The above results show that after annealing, the pipes show dramatically improved dimensional stability. These results are in line with the predictable molecular stress relatation which should occur as one of the structural mechanisms taking place during the annealing process.

Such high dimensional stability would be of particular interest for piping systems intended to convey hot fluids, and for pipelines susceptible to large soil temperature variations.

Ring Stiffness: According to Standard EN ISO 9969

An average value was determined from tests on 3 samples 300 mm long, taken from either solid wall 110 mm pipes or structured twin-wall 200 mm pipes.

At room temperature, the pipe was laid horizontally between two plates and compressed at a constant rate of 5 mm/minute, until a vertical deformation of 3% of the initial inner diameter was reached. The force F necessary to reach this deformation was measured and the following calculation of stiffness Sₖ made for each pipe sample

$$\begin{matrix}: {S}_{k} = ( 0.0186 + 0.025 \cdot \frac{{y}_{k}}{{d}_{int}} ) \cdot \frac{{F}_{k}}{{L}_{k} \cdot {y}_{k}} \\ ( where \text{:} {y}_{k} = 0.03 \times {d}_{{int}_{( k )}} and \text{:} {d}_{int} = \frac{\sum {d}_{{int}_{( k )}}}{3} )\end{matrix}$$

Finally average S value was calculated.

Performance requirements are:

S≧4 kN/m² for S16 class (SN4; SDR 33) (for solid-wall pipes as used in this test)

S≧6.3 kN/m² for S14 class

S≧8 kN/m² for S11.2 class (SN8; SDR 23.4) (for twin-wall pipes as used in this test) S≧16 kN/m² for SN16 class (for structured twin-wall pipes) Tables 3-5 below.

TABLE 3
solid wall 110 mm pipes

| | Ring Stiffness | % increase |
|---|---|---|
| | @ 23° C. | relative to non- |
| EXAMPLE | [kN/m²] | annealed |
| 1-Non annealed | 5.62 | — |
| 1-Annealed 3h | 6.44 | +14.6% |
| 1-Annealed 6h | 6.42 | +14.2% |
| 1-Annealed 12h | 6.49 | +15.5% |
| 1-Annealed 24h | 6.52 | +16.0% |
| 2-Non annealed | 4.59 | — |
| 2-Annealed 3h | 5.28 | +15.0% |
| 2-Annealed 6h | 5.46 | +19.0% |
| 2-Annealed 12h | 5.25 | +14.4% |
| 3-Non annealed | 7.19 | — |
| 3-Annealed 3h | 7.91 | +10.0% |
| 3-Annealed 6h | 7.84 | +9.0% |
| 3-Annealed 12h | 7.84 | +9.0% |
| 4-Non annealed | 6.44 | — |
| 4-Annealed 12h | 7.14 | +10.9% |

TABLE 4
structured twin wall 200 mm pipes

| | Ring Stiffness | % increase |
|---|---|---|
| | @ 23° C. | relative to non- |
| EXAMPLE | [kN/m²] | annealed |
| 3-Non annealed | 13.28 | — |
| 3-Annealed 6h | 13.48 | +1.5% |
| 4-Non annealed | 11.99 | — |
| 4-Annealed 6h | 13.03 | +8.7% |

The above results indicate that the annealing process does not result in any reduction in pipe rigidity; on the contrary, it actually results in a marked increase in ring stiffness. This is true especially for solid wall pipes, where an increase of about 10 to 15% in ring stiffness is observed; but it is also the case for structured twin-wall pipes, though to a lower extent.

Moreover, for all resins, this increase in ring stiffness is achieved even for the shortest annealing times.

Creep Ratio: According to Standard EN ISO 9967

This test is intended to simulate the compressive effects of soil settlement (natural+traffic)

An average value was determined from tests on 3 samples 300 mm long, taken from 110 mm solid wall pipes.

A pre-load F₀ was initially applied at room temperature, by compressing vertically a pipe sample laid horizontally between two plates, with the force applied F₀[N]=75 dᵢₙₜ [m] (where dᵢₙₜ is the average inner diameter). 5 minutes after application of the pre-load, the deformation gauge was reset and a force F was applied progressively (over 20-30 sec.) such that after 6 minutes under this load the vertical deformation of the sample was 1.5%±0.2%. Once the full force had been applied, timing was started, and the deformation at different times measured: after 6 minutes (called y₀), 1 h, 4 h, 24 h, 168 h, 336 h, 504 h, 600 h, 696 h, 840 h, and 1008 h. By plotting deformation against log time, the value Y₂ of the deformation at 2 years (=17,520 h) was extrapolated by linear regression.

The creep value for each sample is given by:

$${γ}_{k} = \frac{{Y}_{{2}_{( k )}} \cdot ( 0.0186 + 0.025 \cdot \frac{{y}_{{0}_{( k )}}}{{d}_{int}} )}{{y}_{{0}_{( k )}} \cdot ( 0.0186 + 0.025 \cdot \frac{{Y}_{{2}_{( k )}}}{{d}_{int}} )}$$

from which an average value was taken.

The performance requirement is that □≦4 for both solid wall pipes and structured twin-wall pipes. The results are shown in Table 5 below.

TABLE 5

| | Creep Ratio @ | % increase relative to |
|---|---|---|
| | 23° C. | non-annealed |
| 1-Non annealed | 3.0 | — |
| 1-Annealed 24 h | 2.4 | −20% |

These results show that annealing reduces the creep ratio by around 20%, providing a substantial increase in the capacity of buried pipes to minimise long-term deformation through creep, when they are submitted to stresses stemming from the settlement of the surrounding soil and backfill.

Hydrostatic Pressure Pipe Tests: According to Standard EN 921

An average value was determined from tests on 3 samples=775 mm long, taken from solid wall 110 mm pipes. Tests were performed in water with the following requirements:

Either 80° C./4.2 MPa: NO rupture before 140 hours

Or 95° C./2.5 MPa: NO rupture before 1000 hours

Results are shown in Table 6.

TABLE 6

| | | % increase | Time to | |
|---|---|---|---|---|
| | | (mean) | failure | % increase |
| | Time | relative to | 95° C./2.5 | (mean) |
| | to failure | non- | MPa | relative to |
| EXAMPLE | 80° C./4.2 MPa [h] | annealed | [h] | non-annealed |
| 1-Non annealed | 427; 676; 450 | — | 559; 586; | — |
| | | | 1069* | |
| 1-Annealed 3 h | 139*; >1986; | >+251% | — | — |
| | 1650 | | | |
| 1-Annealed 6 h | 2x: >1657 | >+220% | — | — |
| 1-Annealed 12 h | 1080; 2992; | >+269% | 1040; 2x: >1182 | >+98% |
| | 1657 | | | |
| 1-Annealed 24 h | 2x: >800 | — | 3x: >1242 | >+117% |
| 2-Non annealed | 189; 77; 126 | — | 63; 93; 104 | — |
| 2-Annealed 3 h | 492; 293; 600 | +253% | — | — |
| 2-Annealed 6 h | 412; 249; 138 | +104% | — | — |
| 2-Annealed 12 h | 255; 253; 743* | +94% | 301; 343; | +271% |
| | | | 893* | |
| 4-Non Annealed | — | — | 2463; 2x: >2707 | — |
| 4-Annealed 12 h | — | — | 3x: >1242 | — |

All failures were brittle.
*Values crossed out are considered as unreliable results
>Test voluntarily stopped before failure

These results show that the annealing process induces a substantial improvement in resistance to brittle failure by the slow crack growth mechanism, which prevails at high temperatures under low pressures in thermoplastic piping systems. This is true whatever the conditions are 80° C./4.2 MPa or 95° C./2.5 MPa. Clearly therefore annealed pipes show a dramatically improved resistance to environmental stress cracking, and would thus offer a safer long-term service life in operating conditions.

The annealing process at 140° C. allows the polymer of Example 1 to safely comply with the >1,000 hours criterion in the 95° C./2.5 MPa test as required by relevant standards in the non-pressure pipe market. It also allows the polymer of Example 2 to safely comply with the >140 hours criterion in the 80° C./4.2 MPa test.

As in the case of Ring Stiffness measurements, it can be seen that annealing for just 3 hours at 140° C. is sufficient to provide the enhancement in stress cracking resistance It is not necessary to anneal for longer.

Impact Testing/“Staircase” Method: According to Standard EN 1411

An average value was determined from tests on 3 samples 200 mm long, taken from solid wall 110 mm pipes, or structured twin-wall 200 mm pipes; each sample was used for one sole impact test. The striker used was a type d90 (large & hemispherical). The samples were laid in a metallic 120° angle V-shaped support. For the preliminary test, the striker was dropped from a height of 0.50 m to find the height Hp corresponding to the first failure of a sample, which was done by successively increasing (or decreasing) the dropping height in increments of 0.20 m.

For the principle test the first impact was done at Hₚ-0.1 m. If there was no failure, the height was increased in 0.1 m increments until the occurrence of a failure; if there was failure at Hₚ-0.1 m, the height was decreased in 0.1 m increments until the occurrence of a non-failure. This procedure was repeated until 20 samples had been tested in the principle test, with the additional condition that of these 20 impacts at least 8 failures and 8 non-failures had been observed. The average of all the dropping heights used in the principle test was designated the H₅₀ value.

Note: failure was considered to be a bursting, a crack or a cut on the internal face of the pipe wall; a mark or a pleat on the external face was not considered as a failure.

Requirements according to the relevant European standards for the non-pressure pipe market:

For solid wall 110 mm pipes—0° C./4 kg: H₅₀ 1 m, with maximum of 1 break below 0.50 m

For structured twin-wall 200 mm pipes—0° C./8 kg: H₅₀≧1 m, with no failures below 0.50 m

Additionally, there are also more stringent national standards for low-temperature environments:

For 200 mm pipes:

H₅₀≧0.75 m at −20° C./8 kg (with striker type C) for the Swedish SS361 standard.

H₅₀≧1 m at −20° C./8 kg (with striker type d50) for the Finnish SFS3453 standard.

Results are shown in Tables 7 and 8 below.

TABLE 7
structured twin wall 200 mm pipes

| | | % increase | | |
|---|---|---|---|---|
| | | relative to | −30° C./8 kg | % increase |
| | −20° C./8 kg | non- | H₅₀ value | relative to |
| EXAMPLE | H₅₀ value [m] | annealed | [m] | non-annealed |
| 3 | 1.46 | — | 0.39 | — |
| non annealed | | | | |
| 3 | >2.20 | >+51% | 1.88 | +382% |
| annealed 3 h | | | | |
| 3 | 2.14 | +47% | 2.09 | +436% |
| annealed 6 h | | | | |
| 4 | 1.09⁽*⁾ | — | 0.52 | — |
| non annealed | | | | |
| 4 annealed 3 h | 2.10 | +93% | 2.23 | +329% |
| 4 annealed 6 h | >2.26 | >+107% | >2.26 | >+335% |

TABLE 8
non-annealed samples

| | | | −10° C./8 kg |
|---|---|---|---|
| | −20° C./4 kg | −20° C./8 kg | H₅₀ value |
| | H₅₀ value [m] | H₅₀ value [m] | [m] |
| 1 | >2.20 m | >2.20 m | — |
| solid wall 110 mm pipe | | | |
| 2 | >2.20 m | >2.20 m | — |
| solid wall 110 mm pipe | | | |
| 3 | >2.20 m | >2.20 m | — |
| solid wall 110 mm pipe | | | |
| 4 | >2.20 m | >2.20 m | — |
| solid wall 110 mm pipe | | | |

It can be seen from the above that the annealing process results in a dramatic improvement in the impact resistance of the structured twin-wall 200 mm pipes. The 15H₅₀ value is increased by 50-100% at −20° C. and is increased by more than 300% at −30° C.

Both Examples 3 and 4 comfortably pass all the European standards in the field of structured twin-wall pipes for non-pressure applications such as sewerage and drainage (see prEN 13476-1): H₅₀≧1 m at 0° C./8 kg, without any breakage below 0.50 m. However, for some specific countries, especially the Nordic ones (Finland, Sweden, Norway), the national standards are even more stringent and actually require the same at −10° C. or even −20° C.: see e.g. Swedish SS3619 or Finnish SFS3453. Both Examples 3 and 4 could comply with those standards, but the annealing process enables these materials to exceed even these most stringent requirements: for annealed pipes, the H₅₀ is beyond 2 metres even at −30° C./8 kg. Again, it can be seen that annealing at 140° C. for just 3 hours is sufficient.

For solid wall 110 mm pipes, the non-annealed samples exceed the European standards and even the Nordic ones in any case; for them, annealing is of less value for this particular property.

Impact/Instrumented Falling Weight:

This test was effected by means of an apparatus equipped with a thermostatised chamber. The curves of deflection as a function of force were analysed according to ISO standard 6603. The impact velocity was 6.26 m/s, the weight of the striker was 6.21 kg and the total energy of the striker just before impact was 121.8 J. The pipe samples about 30 cm long were fixed on a V-shaped steel support. The tip of the hardened steel striker (here so-called “V-form” striker) had the shape described in ISO standard 179, a radius of 2 mm and an angle of 300 and was positioned in the length direction perpendicular to the direction of the length of the pipe. The length of the striker was 30 mm.

An average value was determined from tests on 6 samples 200 mm long, taken from solid wall 110 mm pipes. The conditions were as follows: hammer falling height=2 m; weight=6.21 kg The force as a function of time was monitored in real-time, starting from the hammer launching, and the energy of the impact calculated by performing successive integration procedures, allowing the resilience to be estimated. Additionally, the form of the curve allows determination of whether the failure is brittle or ductile.

Results are shown in Tables 9 and 10.

TABLE 9

| | Resilience | % increase | |
|---|---|---|---|
| | @ | relative to non- | |
| EXAMPLE | −30° C. [J/mm] | annealed | type of failure |
| 1-Non annealed | 9.4 | — | brittle |
| 1-Annealed 3 h | 21.1 | +124% | brittle/ductile |
| 1-Annealed 6 h | 21.9 | +133% | ductile |
| 1-Annealed 12 h | 21.9 | +133% | ductile |
| 1-Annealed 24 h | 21.9 | +133% | ductile |
| 2-Non annealed | 22.1 | — | brittle |
| 2-Annealed 12 h | NO rupture | — | — |
| 3-Non annealed | 7.5 | — | brittle |
| 3-Annealed 12 h | 22.8 | +204% | ductile |
| 4-Non annealed | 8.8 | — | brittle |
| 4-Annealed 12 h | 24.0 | +173% | ductile |

TABLE 10a

| | Resilience | % increase | |
|---|---|---|---|
| | @ −50° C. | relative to non- | type of |
| | [J/mm] | annealed | failure |
| 2-Non annealed | 11.6 | — | brittle |
| 2-Annealed | 22.6 | +95% | brittle |
| 12 h | | | |

TABLE 10b

| | Resilience | % increase | |
|---|---|---|---|
| | @ −40° C. | relative to non- | |
| | [J/mm] | annealed | type of failure |
| 1-Non annealed | 8.4 | — | brittle |
| 1-Annealed 24 h | 11.4 | +36% | brittle |
| 2-Annealed 12 h | NO rupture | — | — |

TABLE 10c

| | Resilience | % increase | |
|---|---|---|---|
| | @ −20° C. | relative to non- | |
| | [J/mm] | annealed | type of failure |
| 3-Non annealed | 15.4 | — | brittle |
| 3-Annealed 12 h | 21.2 | +37% | ductile |

The annealing process results in an substantial increase in the impact resilience at −30° C. of 110 mm solid wall pipes. These results corroborate the observation of enhancement of impact resistance in the “staircase method” for structured twin-wall 200 mm pipes.

The resilience (−30° C./2 m/6.3 kg/“V-form” kind of hammer) is increased by 130% for Example 1 and by 170-200% for Examples 3 and 4.

Some results for other measurements at lower temperatures can be found in Tables 10a-10c. However, results at −30° C. show more evidence of the annealing effect.

As is shown in Table 11 below, annealing at 140° C. not only increases impact resilience of pipes and fittings, but also shifts the ductile-brittle transition temperature downwards: T°_{DB} is decreased at least from 10° C.

TABLE 11

| | Ductile-Brittle transition temperature |
|---|---|
| 1-Non annealed | above −30° C. |
| 1-Annealed 12 h | in between −40° C. and −30° C. |
| 2-Non annealed | above −30° C. |
| 2-Annealed 12 h | in between −50° C. and −40° C. |
| 3-Non annealed | above −20° C. |
| 3-Annealed 12 h | below −30° C. |
| 4-Non annealed | above −30° C. |
| 4-Annealed 12 h | below −30° C. |

1. Process for the manufacture of pipes and fittings, comprising a first stage of making a pipe or a fitting from a propylene polymer based composition comprising:
from 76 to 98 parts by weight of a crystalline homopolymer of propylene or of a crystalline statistical copolymer (A) of propylene which may contain up to 1.5% molar of monomer units derived from ethylene and/or from an alpha-olefin containing from 4 to 6 carbon atoms,
from 24 to 2 parts by weight of a statistical copolymer (B) containing from 40 to 70% molar of monomer units derived from ethylene and/or from an alpha-olefin containing from 4 to 6 carbon atoms,
and a second stage of annealing said pipe or fitting by beating for a period of between one hour and three days at a temperature between 110 and 155° C.

2. Process according to claim 1, in which the first stage comprises an extrusion step, followed by a cutting operation.

3. Process according to claim 1, in which the first stage comprises an injection-moulding step.

4. Process according to any one of claims 1 to 3, in which the composition has a melt fluidity index of 0.05 to 1.5 g/10 minutes.

5. Process according to any one of claims 1 to 4, in which the composition has an intrinsic viscosity ratio of polymer (B) to polymer (A) of 0.8 to 3.

6. Process according to any one of claims 1 to 5, in which the composition is obtained by a process comprising at least two successive polymerisation stages in the course of which polymers A and B are prepared.

7. Process according to any preceding claim, wherein the heating in the annealing step lasts for at least 2 hours.

8. Process according to claim 7, wherein the heating in the annealing step lasts for at least 3 hours.

9. Use of pipes and fittings obtained according to any one of claims 1 to 8 for the conveying of low-pressure fluids.

10. Use of pipes and fittings obtained according to any one of claims 1 to 8 for the conveying of fluids under pressure.
